(19) United States
(12) Patent Application Publication
(10) Pub. No.: US 2008/0071656 A1
(43) Pub. Date: Mar. 20, 2008

(54) METHOD FOR CONSTRUCTING SEARCHABLE DATA PATTERNS OF INTEREST

(75) Inventors: Gregg Katsura Steuben, Clifton Park, NY (US); Bethany Kniffin Hoogs, Niskayuna, NY (US); Kareem Sherif Aggour, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 11/532,213

(22) Filed: Sep. 15, 2006

(51) Int. Cl. G06Q 40/00

(52) U.S. Cl. 705/35

(57) ABSTRACT

A method for constructing data patterns of interest is provided. The method includes creating one or more alert clause expressions and evaluating the one or more alert clause expressions based on a parameter of interest and a plurality of conditions. The method further includes combining the one or more alert clause expressions in a selected manner to generate an alert signal. The one or more data patterns of interest are described by the one or more alert clause expressions and the alert signal.

### BACKGROUND

The invention relates generally to techniques for targeted information extraction and more particularly to a method for constructing customized data patterns of interest from a dataset.

Information extraction systems typically analyze vast amounts of data, including qualitative and quantitative information. A variety of data mining techniques have been employed by information extraction systems to search for pieces of useful information. For example, in the financial domain, data is typically analyzed to determine the financial health of a company. An understanding of a company's financial health can be used to help evaluate risks involved in doing business with that company, and can form a basis for predicting the expected benefits from a potential business relationship or transaction.

In addition, financial analysts, such as managers of investment portfolios, analysts working for companies extending credit, and loan officers, make decisions every day based on perceptions of a company's financial health. Taken at its simplest, financial analysts look for any financial data that doesn't seem to fit in, either because it represents an unusual financial circumstance for the company (which may indicate poor financial health), or because it doesn't conform to the analyst's existing knowledge of the company's financial circumstances (which may indicate improper or fraudulent financial reporting). Such ‘out of the ordinary’ financial data is referred to generally as an ‘anomaly’. Properly recognized and understood, financial anomalies can act as early warning signs of financial decline or fraud, which can allow an analyst to avoid transactions that are undesirable by recognizing developing problems before they happen. A financial analyst would like to detect any financial anomalies as early as possible and with as great a degree of confidence as possible.

The detection of such anomalies or relevant patterns of interest has traditionally involved the analysis of large amounts of qualitative and quantitative information. However, searching for relevant data patterns of interest in large datasets in a reasonable amount of time becomes increasingly complex as the amount of data present in such information extraction systems grows with time.

It would therefore be desirable to develop a technique to search for specific patterns of interest present in large volumes of data in a reasonable amount of time. It would also be desirable to develop a technique to construct personalized patterns of interest that may automatically be searched while mining such large volumes of data. In addition, it would also be desirable to develop a user interface that enables a user to create customized data patterns of interest for which a user would like to be notified.

### BRIEF DESCRIPTION

Embodiments of the present invention address this and other needs. In one embodiment, a method for constructing data patterns of interest is provided. The method includes creating one or more alert clause expressions and evaluating the one or more alert clause expressions based on a parameter of interest and a plurality of conditions. The method further includes combining the one or more alert clause expressions in a selected manner to generate an alert signal. The one or more data patterns of interest are described by the one or more alert clause expressions and the alert signal.

In another embodiment, a method for constructing data patterns of interest is provided. The method includes creating one or more alert clause expressions and combining the one or more alert clause expressions in a selected manner to generate an alert signal. The one or more data patterns of interest are described by the one or more alert clause expressions and the alert signal. The method further comprises displaying an alert status associated with the generated alert signal.

### DRAWINGS

These and other features, aspects, and advantages of the present invention will become better understood when the following detailed description is read with reference to the accompanying drawings in which like characters represent like parts throughout the drawings, wherein:

FIG. 1 illustrates a process for constructing data patterns of interest in accordance with one embodiment of the present invention;

FIG. 2 is a screen display illustrating the creation of an alert clause expression in accordance with one embodiment of the present invention;

FIG. 3 is a screen display illustrating the creation of an alert clause expression in accordance with another embodiment of the present invention;

FIG. 4 is a screen display illustrating the creation of an alert clause expression in accordance with yet another embodiment of the present invention;

FIG. 5 is a screen display illustrating the creation of an alert signal in accordance with one embodiment of the present invention;

FIG. 6 is a screen display illustrating the creation of an alert signal in accordance with another embodiment of the present invention;

FIG. 7 is a screen display illustrating the utilization of patterns of interest captured by one or more alert signals, by using the one or more alert signals as search criteria; and

FIG. 8 is a screen display illustrating an anomaly map generated for an alert signal.

### DETAILED DESCRIPTION

Embodiments of the present invention disclose a technique for constructing customized data patterns of interest from a dataset and detecting specific conditions or inconsistencies from the data patterns of interest. As will be described in greater detail below, the data patterns of interest may be constructed using several types of conditions/clauses involving different data attributes and attribute values. In one embodiment, the data patterns of interest correspond to one or more business behavioral patterns, such as declining financial health and misleading financials associated with a target company. However, it will be appreciated by those skilled in the art, that the disclosed technique in general may be applicable to any domain that involves the monitoring of data to detect desirable and undesirable conditions and exceptions in the data, such as, for example, in the identification of pending fault situations in power-generating turbines by detecting patterns in the output of sensors providing temperature and pressure values, among other readings, from the turbines in a fleet. For example, by monitoring high exhaust temperature in a fleet of turbines, the occurrence of different types of fault or failure conditions, such as temperature control card failures, gas supply failures and gas purge system problems may be predicted, a specific number of hours in advance, so that appropriate preventive action may be taken. Other applications of the disclosed technique include monitoring stock trading data to identify possible insider trading or other unusual trading floor occurrences, and monitoring sensors from aircraft engines to detect any undesirable conditions.

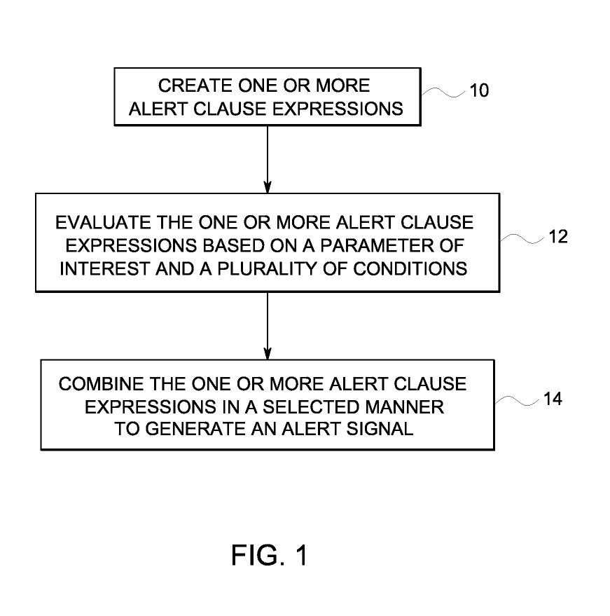

FIG. 1 illustrates a process for constructing data patterns of interest in accordance with one embodiment of the present invention. In step 10, one or more alert clause expressions are created. In one embodiment, an alert clause expression specifies an expression to be evaluated, a time frame including a minimum and maximum number of times that the expression must be satisfied during those time instances for the alert clause expression to evaluate to true, a unique name identifying the alert clause expression and an optional textual description describing the alert clause expression. As will be described in greater detail below, an “alert status”, describing a particular behavioral pattern associated with a target company, is triggered when specific conditions represented by the one or more alert clause expressions are met. In other words, the “alert status” specifies whether the alert clause expression must be “triggered” (i.e., occurred) or “non-triggered” (i.e. did not occur) for the alert clause expression to evaluate to “true”.

Referring to FIG. 1 again, in step 12, the one or more alert clause expressions are evaluated based on a parameter of interest and a plurality of conditions. In a particular embodiment, evaluating the one or more alert clause expressions comprises pre-processing the one or more alert clause expressions and storing the pre-processed alert clause expressions in a database. As will be described in greater detail below, the evaluated alert clause expressions may be subsequently used in the efficient generation of one or more alert signals.

In one embodiment, the parameter of interest includes one or more financial metrics associated with a target company. As discussed herein, a ‘financial metric’ may be any piece of financial data that is associated with the performance or operation of a company over a particular time period. For instance, a classic financial metric is net income. Other financial metrics include, but are not limited to: total revenue; inventory on hand; capital expenses; interest payments; debt; accounts payable; and earnings before interest, taxes, depreciation and amortization (EBITDA).

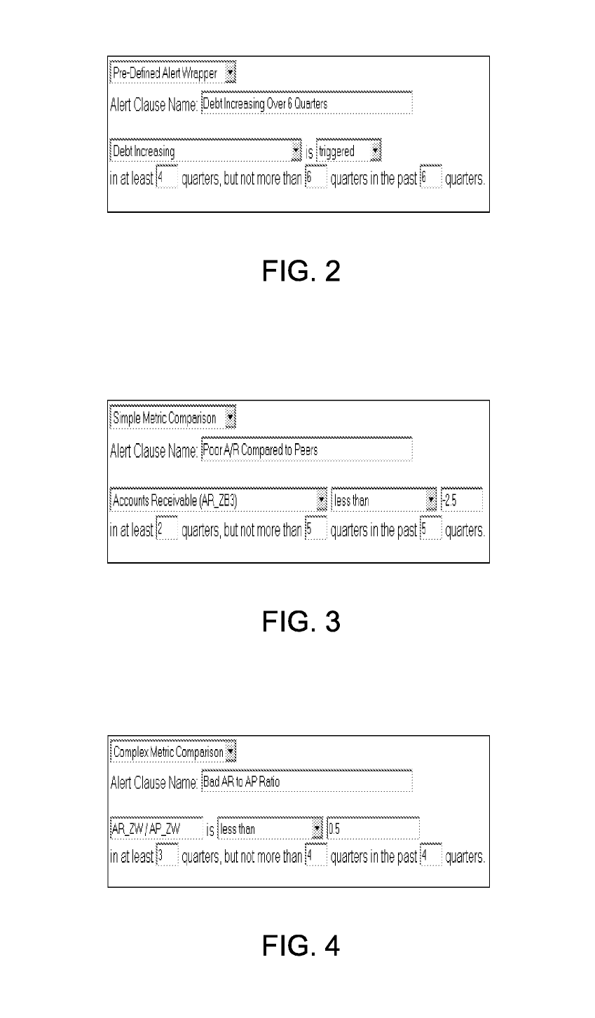

FIGS. 2-4 are exemplary illustrations of screen displays that may be presented to a user for the creation of an alert clause expression in accordance with embodiments of the present invention. The screen displays shown in FIGS. 2-4 are for illustrative purposes only and are not exhaustive of other types of displays that could be presented to a user or the displays that can be presented in other possible embodiments. Also, the actual look and feel of the displays can be slightly or substantially changed during implementation.

FIG. 2 is a screen display illustrating the creation of an alert clause expression in accordance with one embodiment of the present invention. As illustrated in FIG. 2, a user selects the type of alert clause expression to be created, the alert clause name, one or more alert clause conditions and an alert status. In one embodiment, the alert clause expression is referred to as a “pre-defined alert wrapper” and the alert status associated with this alert clause expression is triggered when one or more alert clause conditions are satisfied. As used herein, a “pre-defined alert wrapper” refers to a class that wraps one or more primitive values in a pre-defined alert class.

Referring to FIG. 2, the user selects the alert clause name, “Debt increasing over 6 quarters” from a list of pre-defined alerts. The pre-defined alert clause expression “Debt increasing over 6 quarters” evaluates to true if the pre-defined alert clause “Debt increasing over 6 quarters” is triggered in at least 4 quarters out of the last 6 quarters. As may be observed from the screen display illustrated in FIG. 2 a user enters “4” for the minimum number of quarters, “6” for the maximum number of quarters and “6” for the number of past quarters.

FIG. 3 is a screen display illustrating the creation of an alert clause expression in accordance with another embodiment of the present invention. As illustrated in the screen display shown in FIG. 3, a user selects the type of the alert clause expression to be created, the alert clause name, a financial metric, a comparison operator and one or more alert clause conditions. In one embodiment, the alert clause expression is referred to as a “Simple Metric Comparison Alert Clause”. In a particular embodiment, the “Simple Metric Comparison Alert Clause” compares a value indicated by the financial metric related to a target company relative to one or more peers related to the target company and evaluates to true if the value indicated by the metric field satisfies the comparison with the value. The comparison operator may include, but is not limited to, “equal to”, “less than”, “greater than”, “less than or equal to”, or “greater than or equal to” operators.

As may be observed from the screen display illustrated in FIG. 3, the user chooses the alert clause expression, “Simple Metric Comparison” and selects “Poor A/R Compared to Peers” as the alert clause name and “Accounts Receivable” from the list of available metrics. In the particular example shown in FIG. 3, the user selects “less than” as the comparison operator and enters “−2.5” as the value to compare against. Accordingly, the alert clause expression is triggered (i.e. evaluates to true) when the chosen metric is more than 2.5 standard deviations away (i.e., in a “bad direction”) from the mean of the company's peers. As may further be observed from FIG. 3, the alert clause expression evaluates to true if the above conditions are met in at least 2 of the 5 most recent quarters.

FIG. 4 is a screen display illustrating the creation of an alert clause expression in accordance with yet another embodiment of the present invention. As illustrated by the screen display of FIG. 4, the user selects the type of the alert clause expression to be created, the alert clause name, a financial metric, a comparison operator and one or more alert clause conditions. In one embodiment, the type of alert clause expression is referred to as a “Complex Metric Comparison” and includes an arithmetic expression on each side of the comparison operator. The arithmetic expression may include arithmetic operators, such as, addition, subtraction, multiplication and division, numerical scalars and Z-scores. As used herein, a “Z-score” refers to a statistical technique used to evaluate the degree to which a particular value in a group is an outlier, i.e. is anomalous. Typical z-scores are based upon a calculation of the mean and the standard deviation of the group, and the technique for calculating z-scores is well known in the art.

In the particular example shown in FIG. 4, the user chooses the alert clause expression, “Complex Metric Comparison” and selects “Bad AR to AP Ratio” as the alert clause name. The alert clause name “Bad AR to AP Ratio” compares the ratio of the Accounts Receivable (AR) to the Accounts Payable (AP) to a scalar value that the user has determined is a good measure of possible problems with respect to the company's own history. As may be observed from the screen display illustrated in FIG. 4, the user enters “AR_ZW/AP_ZW” in the left-hand expression of the arithmetic expression, “less than” for the comparison operator and the value “0.5” in the right-hand expression. In the particular example shown in FIG. 4, the alert clause expression evaluates to true if the above conditions are met in at least 3 out of the last 4 quarters.

Referring to FIG. 1 again, in step 14, the one or more alert clause expressions are combined in a selected manner to generate an alert signal. In one embodiment, the “alert signal” refers to a logical expression involving the one or more preprocessed alert clause expressions. As used herein, a “logical expression” refers to a combination of logical operators such as AND (&&), OR (∥) and NOT (!) joining one or more statements that can be logically true or false. As will be appreciated by those skilled in the art, the pre-processing of the individual alert clause expressions offline enables the efficient processing and generation of alert signals, since the generation of the alert signal now typically involves only the evaluation of the combined logical expression formed using the one or more pre-processed alert clause expressions. A library of such alert signals may be constructed. The library of alert signals may be shared by multiple users and built to address increasingly complicated and evolving patterns in a manner as will be described in greater detail below.

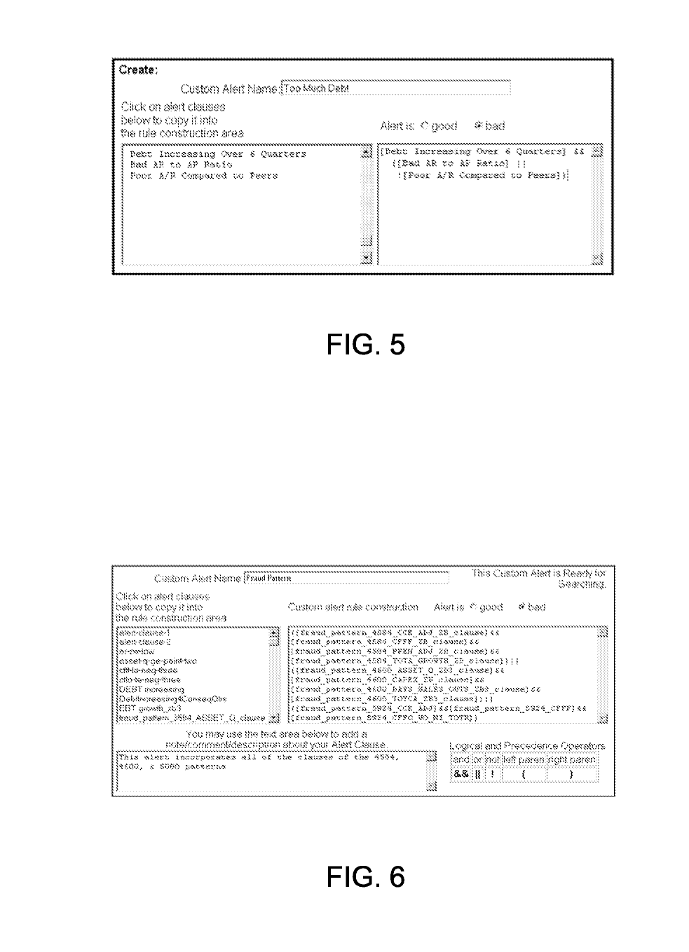

FIG. 5 is a screen display illustrating the creation of an alert signal in accordance with one embodiment of the present invention. As shown in FIG. 5, an alert signal “Too Much Debt” is created using the alert clause expressions, “Debt Increasing over 6 quarters”, “Bad AR to AP Ratio” and “Poor A/R Compared to Peers”. Each alert clause expression is added to a rule construction area and the necessary logical operators (in this example, &&) are inserted between them. In the particular example shown in FIG. 5, the alert signal, “Too Much Debt” evaluates to true if both “Debt Increasing over 6 quarters” and “Poor A/R Compared to Peers” are true. Further, as illustrated by the screen display shown in FIG. 5, a user may indicate the desirability (“good”) or undesirability (“bad”) of the occurrence of the alert signal. The alert signal may be stored in a database and assigned a unique identifier for later reference and retrieval from the database.

FIG. 6 is a screen display illustrating the creation of an alert signal in accordance with another embodiment of the present invention. As shown in FIG. 6, the alert signal, “Fraud Pattern” is composed of a logical combination of several alert clause expressions. As may be observed from the screen display shown in FIG. 6, the alert signal, “Fraud Pattern” is constructed using both logical AND, and logical OR operators as well as parentheses to specify operator precedence. It may also be noted that the same alert clause expressions may be used more than once to create an alert signal.

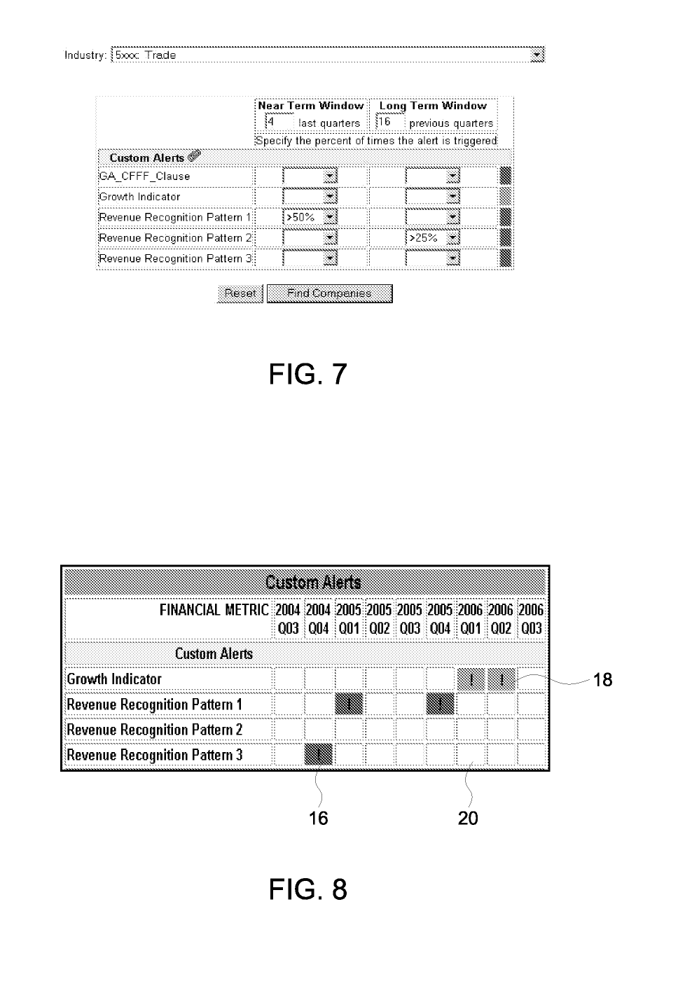

In one embodiment, the alert signal may be used to search for a particular pattern of interest. In a particular embodiment, the alert signal may be used to search through a database using one or more alert clause expressions as query or search criteria. As will be described in greater detail with respect to FIG. 7 below, an alert signal may be used in a search string to identify one or more companies that cause the particular alert signal to be triggered, by marking the alert signal as “searchable” and triggering the alert signal to calculate and store the state of the alert signal for all companies over a specified time period. Accordingly, the alert signal may be used in searches to identify one or more companies that have behaviors or patterns of interest that cause the particular alert signal to be triggered.

FIG. 7 is a screen display illustrating the utilization of patterns of interest captured by one or more alert signals, by using the one or more alert signals as search criteria. The particular example, illustrated in FIG. 7, identifies a set of companies (that have a Standard Industry Classification (SIC) code 5xxx) in the trade industry that exhibit a certain pattern of interest as specified by two alert signals. As illustrated in FIG. 7, the user selects “5xxx: Trade” as the industry and then specifies time interval constraints for the triggering of the alert signals. In the particular example shown in FIG. 7, the alert signal, “Revenue Recognition Pattern 1” must be triggered more than 50% of the time in the most recent 4 quarters (near term) and the alert signal, “Revenue Recognition Pattern 2” must be triggered more than 25% of the time in the previous 16 quarters prior to the 4 near term quarters (i.e., the long term) for the search criteria to evaluate to true. It may be observed that in order for a company to be considered a successful match, all the search criteria must be satisfied.

In another embodiment, the one or more patterns of interest described by the one or more alert clause expressions and the alert signal may be displayed to a user. In particular, an alert status associated with the generated alert signal is displayed for a target company during a particular time period. In a particular embodiment, the alert status may be displayed in an “anomaly map” to a user. As used herein, an “anomaly map” refers to a map of anomalies that provide valuable insight into a target company's financial behaviors against changing industry trends over time. In one embodiment, and as will be described in greater detail with respect to FIG. 8 below, an anomaly map is represented as a table with rows and columns, and a body of cells formed at the intersection of each row and column. Each column generally represents one time period associated with the financial metrics being analyzed. This period may vary based on the availability of the financial metric data, and need not correspond to a specific length of time for every anomaly map. Each row of the anomaly map represents a particular financial metric that was evaluated for the target company. A separate row may be used for each different financial metric evaluated, and the number of rows corresponds to the number of different financial metrics considered for the target company. A detailed description of the generation of anomaly maps is described in copending U.S. patent application Ser. No. 11/028,685 entitled “METHODS AND SYSTEMS FOR VISUALIZING FINANCIAL ANOMALIES” (Attorney Docket 136347) filed on 5 Jan. 2005, the entirety of which is hereby incorporated by reference herein. Once the alert signal is included in the anomaly map, the state of the alert signal as it applies to a target company may be displayed on the target company's anomaly map.

FIG. 8 is a screen display illustrating an anomaly map for an alert signal. As may be observed from FIG. 8, the anomaly map is represented as a graph of time plotted along the X-axis (measured in quarters) and one or more alert signals plotted along the Y-axis. Reference numeral 16, indicates a particular year and quarter for which a negative alert status was triggered, reference numeral 18 indicates the triggering of a positive alert status and reference numeral 20 indicates a period for which an alert status was not triggered. For the particular example shown in FIG. 8, it may be observed that for the alert signal, “Revenue Recognition Pattern 1”, an alert status was triggered for the 1^{st} and 4^{th} quarters of 2005 as indicated by reference numeral 16. Similarly, for the alert signal “Revenue Recognition Pattern 3”, an alert status was triggered in the 4^{th} quarter of 2004 and for the alert signal “Growth Indicator”, an alert status was triggered in the first two quarters of 2006 as indicated by the reference numeral 18.

In another embodiment, the generated alert signal may be verified by applying the alert signal to an individual company. In accordance with a particular implementation, alert signals can be generated using a genetic algorithm. As will be appreciated by those skilled in the art, a “genetic algorithm” refers to a stochastic search technique that is modeled after the process of natural biological evolution. Genetic algorithms typically operate on a population of potential solutions by applying the principle of the survival of the fittest to produce better approximations to a solution. At each generation, a new set of approximations are created by the process of selecting individuals according to their level of fitness in the problem domain and breeding them together using natural genetic operators. This process leads to the evolution of populations of individuals that are better suited to their environment than the individuals that they were created from, just as in natural adaptation.

In a particular embodiment, a group of companies that satisfy one or more criteria, for example, companies that were accused by the US Securities and Exchange Commission (SEC) of committing fraud, are initially identified as a training dataset for the genetic algorithm. The genetic algorithm is executed to identify patterns of interest across the target companies that are not exhibited by companies that were not accused of fraud, based on one or more financial metrics. The patterns of interest are described by an alert signal that reproduces the elements identified in the pattern of interest. In other words, each element identified in the pattern of interest is used to produce an appropriate alert clause expression and these are combined into an alert signal so that they represent the pattern of interest. This new alert signal may then be executed on the entire dataset to verify that it identifies the original set of companies from among all the companies (e.g., the alert signal evaluates to true for the companies used in the genetic algorithm training set). If the verification is successful, the pattern of interest identified by the genetic algorithm is functionally equivalent to the generated alert signal.

The disclosed embodiments have several advantages including the ability to enable a non-programmer to specify patterns of interest in very large datasets and efficiently search and identify entities that match those patterns in the datasets. The alert clause expressions and alert signals generated in accordance with embodiments of the present invention are flexible and configurable, thereby enabling the rapid identification of companies that are of significant interest to an analyst. In addition, the pre-processing of the individual alert clause expressions offline enables the efficient processing and generation of alert signals. With the alert signal capability, non-programmers can specify patterns of interest in the data, store those patterns and have the application automatically discover and report companies that match the pattern. This saves the user/analyst the time that would have been used to analyze each company by hand, making it feasible to both search through a large dataset for a specific custom pattern in a very short time and to monitor many companies. The searching capabilities of alert signals may further be extended to include notifications, enabling analysts to specify patterns of interest that would trigger an email or some other action to notify them.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for constructing data patterns of interest for a dataset, the method comprising:
creating one or more alert clause expressions;
evaluating the one or more alert clause expressions based on a parameter of interest and a plurality of conditions; and
combining the one or more alert clause expressions in a selected manner to generate an alert signal, wherein the one or more data patterns of interest are described by the one or more alert clause expressions and the alert signal.

2. The method of claim 1, wherein the data patterns of interest comprise declining financial health and misleading financials associated with a target company.

3. The method of claim 1, wherein the data patterns of interest comprise pending fault situations in turbine fleet data.

4. The method of claim 1, wherein the parameter of interest comprises one or more financial metrics associated with a target company.

5. The method of claim 4, wherein the financial metric comprises at least one of net income, total revenue, inventory on hand, capital expenses, interest payments, debt, earnings before interest, taxes and depreciation.

6. The method of claim 1, wherein creating the one or more alert clause expressions comprises selecting at least one of an alert clause name, one or more alert clause conditions and an alert clause status.

7. The method of claim 6, wherein evaluating the one or more alert clause expressions comprises triggering an alert status associated with the one or more alert clause expressions, when the one or more alert clause conditions are satisfied.

8. The method of claim 1, wherein creating the one or more alert clause expressions comprises selecting at least one of an alert clause name, a financial metric, a comparison operator and one or more alert clause conditions.

9. The method of claim 8, wherein evaluating the one or more alert clause expressions comprises comparing a value indicated by the financial metric related to a target company relative to one or more peers related to the target company, and wherein the alert clause expression evaluates to true if the value indicated by the financial metric satisfies the comparison with the value.

10. The method of claim 9, wherein the peer companies are in the same industry as the target company.

11. The method of claim 1, wherein evaluating the one or more alert clause expressions comprises pre-processing the one or more alert clause expressions.

12. The method of claim 11, wherein the alert signal is a logical expression involving the one or more pre-processed alert clause expressions.

13. The method of claim 1, further comprising searching for a particular data pattern of interest using the alert signal.

14. The method of claim 13, wherein the alert signal identifies one or more companies having the particular pattern of interest that cause the alert signal to be triggered.

15. The method of claim 1 further comprising displaying the one or more data patterns of interest described by the one or more alert clause expressions and the alert signal.

16. The method of claim 1 further comprising verifying the generated alert signal.

17. A method constructing data patterns of interest in a dataset, the method comprising:
creating one or more alert clause expressions;
combining the one or more alert clause expressions in a selected manner to generate an alert signal, wherein the one or more data patterns of interest are described by the one or more alert clause expressions and the alert signal; and
displaying an alert status associated with the generated alert signal.

18. The method of claim 17, wherein the alert status is displayed for a target company during a particular time period.

19. The method of claim 17, wherein the data patterns of interest comprise declining financial health and misleading financials associated with a target company.

20. The method of claim 17, wherein creating the one or more alert clause expressions comprises selecting at least one of an alert clause name, one or more alert clause conditions and an alert clause status.

21. The method of claim 17, wherein creating the one or more alert clause expressions comprises selecting at least one of an alert clause name, a financial metric, a comparison operator and one or more alert clause conditions.

22. The method of claim 21, further comprising evaluating the one or more alert clause expressions by comparing a value indicated by the financial metric related to a target company relative to one or more peers related to the target company, and wherein the alert clause expression evaluates to true if the value indicated by the financial metric satisfies the comparison with the value.

23. The method of claim 22, wherein evaluating the one or more alert clause expressions comprises pre-processing the one or more alert clause expressions.

24. The method of claim 23, wherein the alert signal is a logical expression involving one or more pre-processed alert clause expressions.

25. The method of claim 17, further comprising searching for a particular data pattern of interest using the alert signal, wherein the alert signal identifies one or more companies having the particular pattern of interest that cause the alert signal to be triggered.
